(19) United States
(12) Patent Application Publication
(10) Pub. No.: US 2016/0174760 A1
(43) Pub. Date: Jun. 23, 2016

(54) Outdoor Cooking Utensil

(71) Applicant: Robert A. Criner, Rimersburg, PA (US)

(72) Inventor: Robert A. Criner, Rimersburg, PA (US)

(21) Appl. No.: 14/974,591

(22) Filed: Dec. 18, 2015

Related U.S. Application Data
(60) Provisional application No. 62/095,921, filed on Dec. 23, 2014.

(51) Int. Cl. A47J 33/00

(52) U.S. Cl. CPC A47J 33/00

(57) ABSTRACT

A cooking utensil (100) having a bipartite shaft (14) slideably and rotatably affixed to a vertical support (24) by a shaft connector (18). The shaft (14) features a fork (26) at a fork end (14bb) and an opposed handle (22). A vertical position of the support is maintained by a stabilizer (20) having a flattened body extending outwards from a thickened central portion having a through bore (20a) receiving the support. The stabilizer is positioned on a ground surface when the cooking tool is in use. The fork is easily positioned and repositioned by rotating the opposed handle, swiveling the handle in a horizontal arc, or tilting the handle in a vertical arc, and its chosen position maintained by a spring loaded device (18c) engaging a spring engaging means (18b) formed in the shaft connector (18).

### CROSS REFERENCE TO RELATED APPLICATIONS

Reference is made to and priority claimed from U.S. provisional application Ser. No. 62/095,921 filed on Dec. 23, 2014.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE OF MATERIAL SUBMITTED ON A COMPACT DISC OR AS A TEXT FILE VIA THE EFS WEB SYSTEM

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention pertains to the field of cooking utensils. More particularly, the present invention is an outdoor cooking utensil for cooking hot dogs and other foods over a campfire or an outdoor stove.

2. Background Art

Cooking outdoors over a gas stove or campfire presents many difficulties. Conventional kitchen utensils are not well adapted for use over an open fire, and thus specialized outdoor cooking utensils are needed for safe cooking. Unfortunately, many utensils touted for outdoor cooking often just feature longer handles, and are not otherwise uniquely designed for outdoor use. Thus, many still resort to cooking standard campfire fare such as hot dogs using wooden sticks held over the fire. Admittedly, finding a suitable stick is fun, but in use, the basic stick leaves much to be desired.

First, a stick is not well adapted for cooking hot dogs, as the hot dog has a tendency to twist and turn on the stick and thus not brown properly on all sides. One solution is to skewer the hot dog lengthwise, but this requires a long thin stick that is nevertheless still strong enough to support the hot dog, and such sticks are not always easily found. Some campers scavenge for a Y-shaped stick so as to more easily secure the hot dog, but finding such a stick is even more troublesome than just finding a long straight skinny stick as the Y-shaped end must be thin enough and to skewer the hot dog, but thick enough to not break under the weight of the meat.

Second, regardless of the type of stick found, the cook still must hold the stick for the entire duration of the cooking process as there is no other alternative for maintaining the hot dog at a proper cooking height over the fire, save asking another person to hold the stick. The weight of the hot dog on one the end of the stick means that a simple staked fishing rod holder, with is essentially a vertical shaft with a Y-shaped holder at its top end, is unsuitable as the hot dog's weight requires a counterweight at the opposite end of the stick, which again is most easily remedied by someone holding the free end and thus defeating the utility of the holder.

Casual or intermittent campers are sometimes willing to put up with the inconveniences of outdoor cooking and make do with utensils currently owned or found, but for those who regularly camp out or spend much time cooking outdoors, the constant inconvenience of inadequate utensils is a nuisance.

What is needed is an adjustable hot dog cooking utensil that securely holds a hot dog for hands-free cooking.

### BRIEF SUMMARY OF THE INVENTION

Accordingly, in a first aspect of the invention, the invention is an outdoor cooking utensil having a bipartite shaft with a fork at one end and a handle at an opposed end, the shaft slideably and rotatably coupled to a vertical support by a shaft connector. The shaft is held in position inside a shaft channel by a spring loaded device allowing the shaft to be adjustably positioned in a vertical or horizontal arc as well as allow forward and backwards positioning of the fork in relation to a fixed position of the vertical support while locking the shaft inside the shaft channel such that the shaft is secured inside the shaft channel.

In still a first aspect of the invention, the bipartite shaft is formed by an inner shaft telescopically coupled to an outer shaft.

In yet another first aspect of the invention, the fork of the cooking utensil is comprised of a pair of prongs arranged as a U-shaped member.

In still yet another first aspect of the invention, the fork is further provided as a pair of removable prongs affixed to a fork connector coupled to the shaft.

In yet another first aspect of the invention, the cooking utensil is further comprised of a stabilizer having a centralized hole formed as a channel in a body of the stabilizer, the hole engaging the support so as to maintain a vertical position of the support when the support is positioned into a ground surface and the stabilizer engages the ground surface.

### BRIEF DESCRIPTION OF THE DRAWINGS

The features and advantages of the invention will become apparent from a consideration of the subsequent detailed description presented in connection with accompanying drawings, in which:

FIG. 1 is a side elevation view of a cooking utensil according to the invention.

FIG. 2 is a perspective view of a shaft connector and a spring loaded device according to the invention.

FIG. 3 is a perspective view of a shaft according to the invention.

FIG. 4 is a perspective view of a fork connector according to the invention.

FIGS. 5a-c are top and cross sectional views of the fork connector of FIG. 4.

FIG. 6 is a perspective view of a support and a stabilizer according to the invention.

FIGS. 7a-c are side elevational and cross sectional views of the stabilizer in FIG. 6.

FIG. 8 is a fork according to the invention.

FIG. 9 is a fork prong according to the invention.

FIG. 10 is a handle according to the invention.

### DRAWINGS LIST OF REFERENCE NUMERALS

The following is a list of reference labels used in the drawings to label components of different embodiments of the invention, and the names of the indicated components.
100 cooking utensil
14 shaft
14a outer shaft
14aa handle end
14b inner shaft
14bb fork end
18 shaft connector
18a support receiving hollow
18b spring receiving means
18c spring loaded device
18d shaft channel
20 stabilizer
20a hole
20a handle
22 support
24a ground end of support
24b connector end of support
26 fork
26a fork connector
26b prong
26c prong receiver
26d shaft receiver

### DETAILED DESCRIPTION OF THE INVENTION

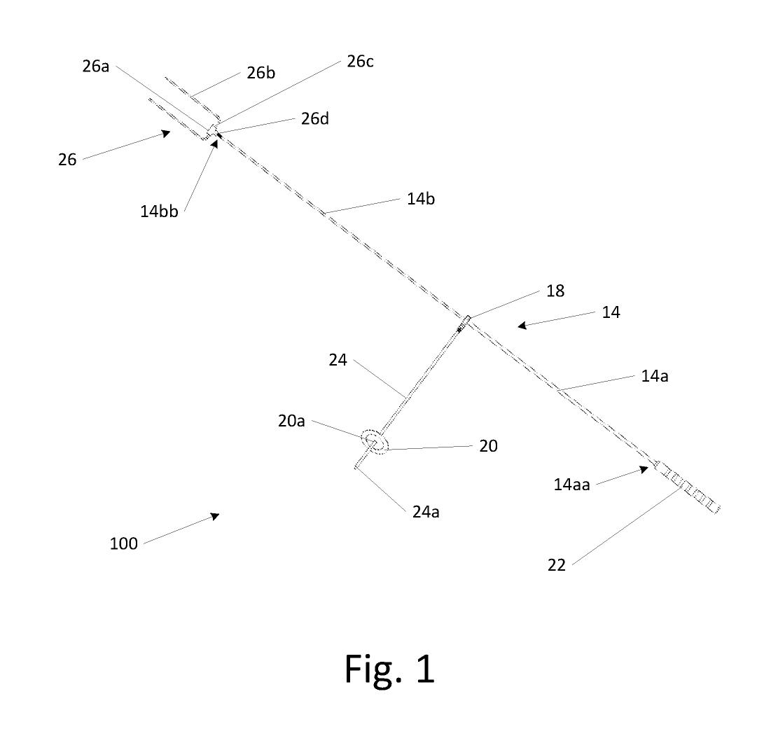

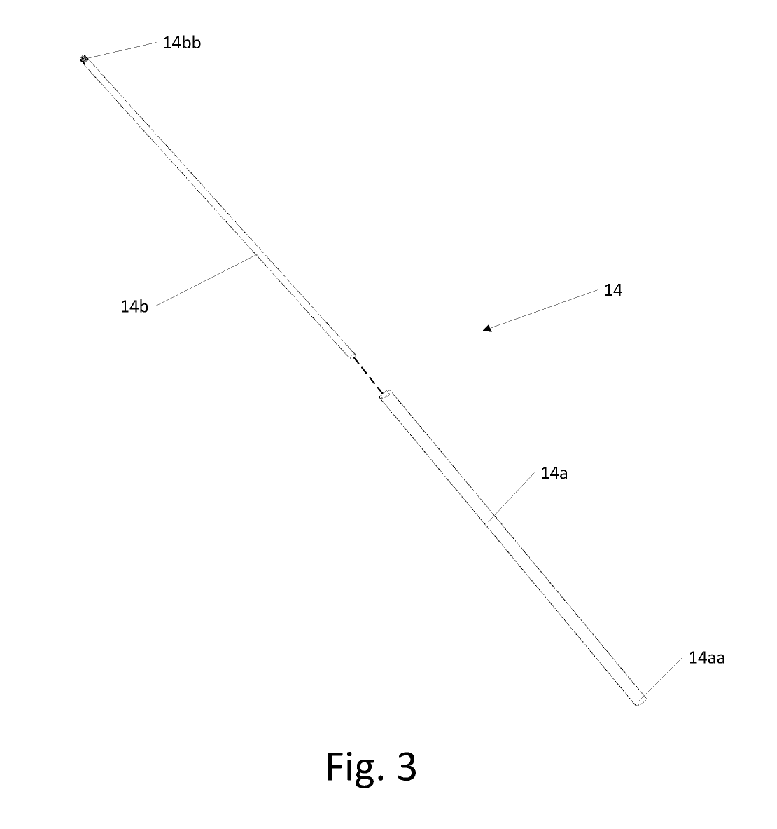

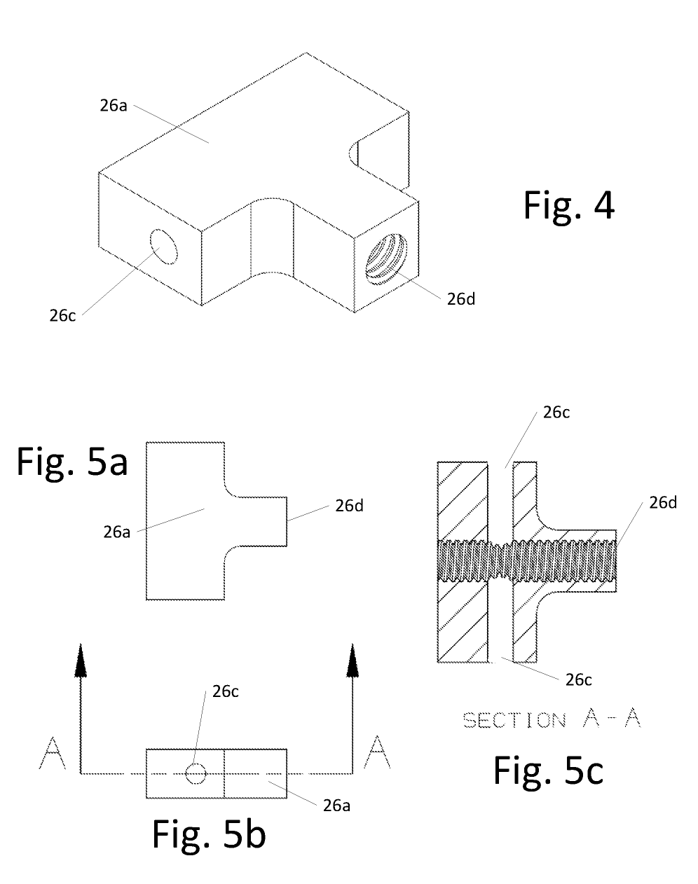

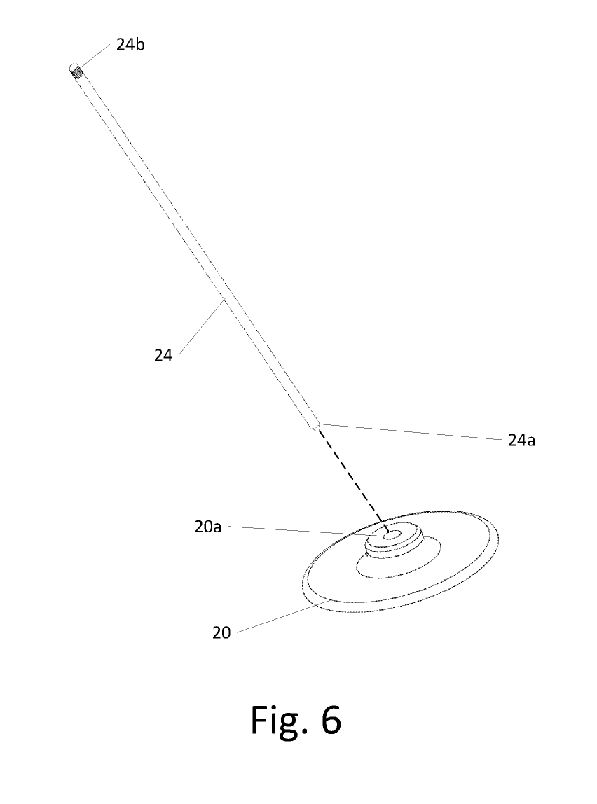

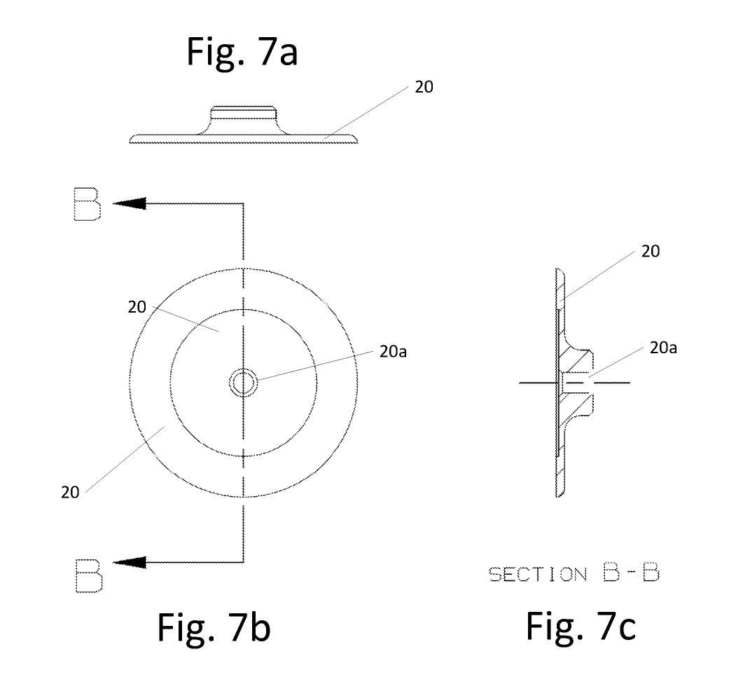

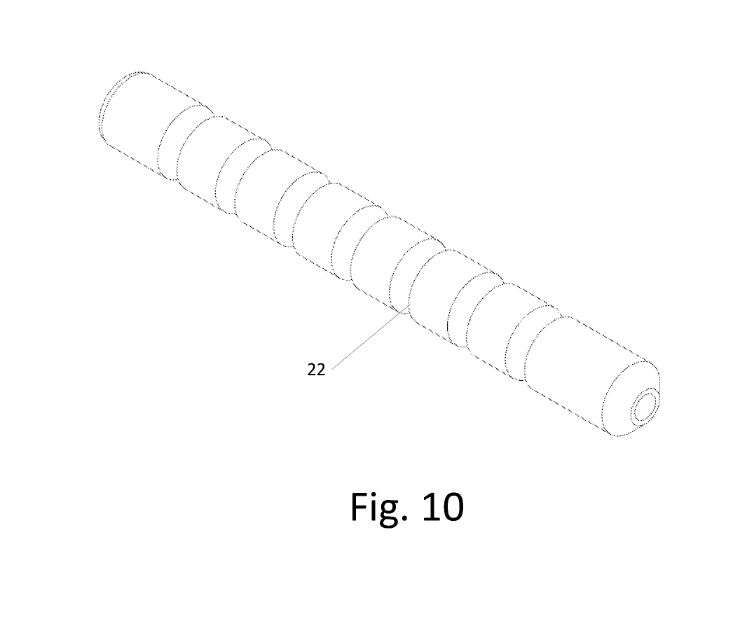

An outdoor cooking tool according to the invention 100 is described in FIGS. 1-10.

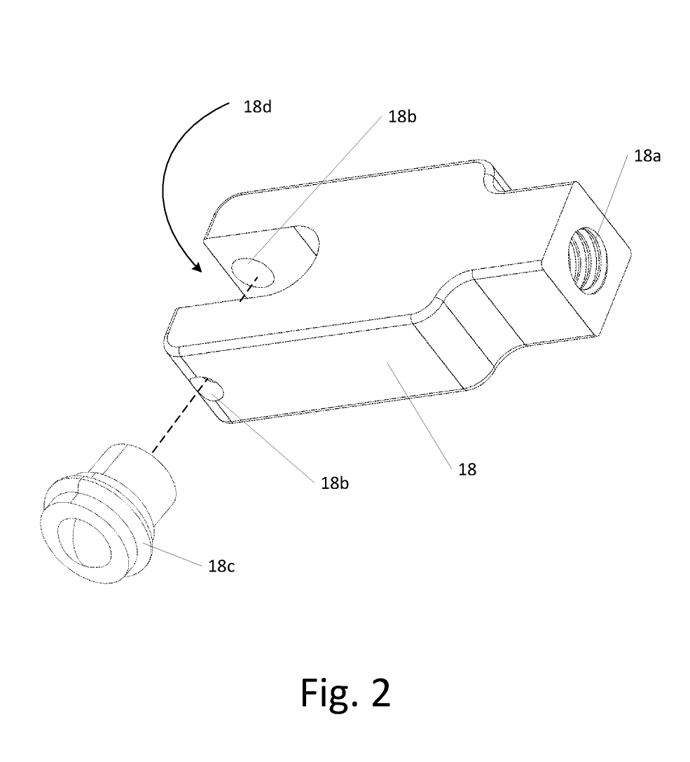

Turning now to the Figures, the outdoor cooking tool 100 is comprised of a bipartite shaft 14 removably affixed to a vertical support 24. A ground end 24a of the support 24 is pushed through a centralized hole 20a of a stabilizer 20, the stabilizer 20 typically configured as a disc having a raised or thickened center portion through which the hole 20a is formed, and a flattened perimeter portion, such that the hole 20a is configured as a channel with increased surface area capable of engaging the support, the stabilizer positioned on the support 24 such that when the ground end 24a engages a ground surface, the stabilizer 20 rests upon the ground surface. A shaft connector 18 (FIG. 2) is fitted onto an uppermost or connector end 24b of the support 24 by coupling the connector end 24b to a support receiving hollow 18a of the shaft connector 18. In a typical embodiment, both shaft connector hollow 18a and connector end 24b are threaded so as to couple by twisting together, although in some other embodiments, the connector end is pressure fitted into the shaft connector hollow. The shaft connector 18 is further provided with a shaft channel 18d, formed by a pair of parallel arms extending upwards and outwards such that the shaft connector approximates a Y-shape. Each arm has a through-passage or spring receiving means 18b in alignment with one another, and adapted to receive a spring loaded device 18c, typically configured as a press fit ball nose spring plunger, such as part number 1368A11 made by McMaster-Carr Company of Aurora Ohio http:/www.mcmaster.com. The inventor has found this particular spring loaded device allows for fast and convenient engagement/disengagement of the bipartite shaft 14, although other devices, such as a simple cotter pin, could be used to hold the bipartite shaft 14 in place. The shaft channel 18d allows the shaft 14 to be moved forwards and backwards (i.e. towards or away from a stationary heat source) and also rotate 360 degrees either clockwise or counterclockwise by simply rotating the shaft in the shaft channel 18d. This movement allows a cook to position the cooking utensil (and any food being cooked) during cooking.

The bipartite shaft 14 further includes an inner shaft 14b pressure-coupled to an outer shaft 14a, a handle end 14aa and a fork end 14bb, a handle 22 located at the handle end 14aa and a fork 26 located at the fork end 14bb. In some embodiments, the inner shaft 14b and outer shaft 14a are decoupled by pulling the shafts 14a 14b apart and storing them separately; in other embodiments, the inner and outer shafts 14b 14a are in telescoping relationship, and a desired overall shaft length is chosen by selectively telescoping portions of said inner shaft 14b out of the outer shaft 14a. The outer shaft 14a can also be configured to threadably receive the inner shaft 14b.

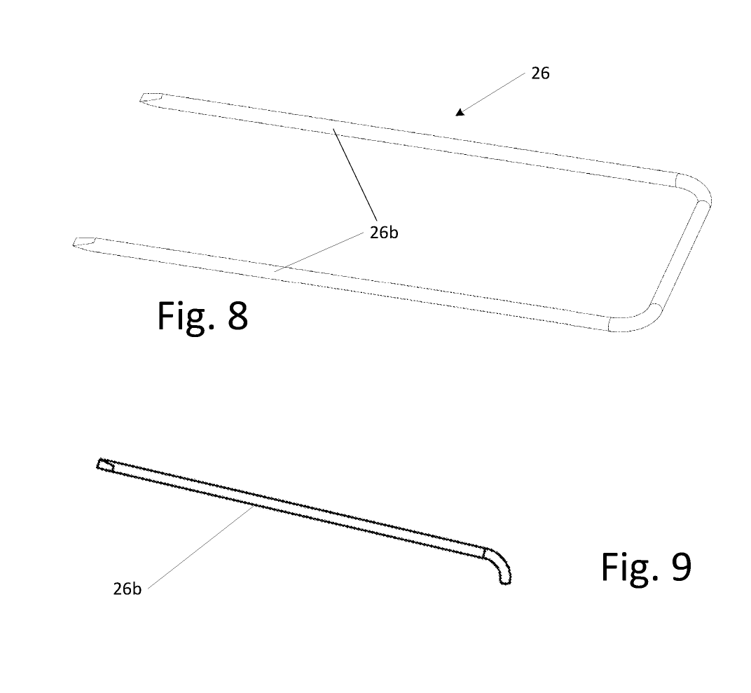

Turning to FIGS. 1, 4, and FIGS. 8-9, the fork 26 is comprised of a T-shaped fork connector 26a coupled to a U-shaped prong 26b by inserting the U-shaped prong 26b into a passage 26c of the T-shaped fork connector 26a (FIG. 8) or alternatively, by coupling a prong 26b (FIG. 9) directly into a passage 26c of the fork connector 26a (FIG. 9). The T-shaped fork connector 26a is further coupled to the shaft by insertion of the fork end 14bb into a receiving bore or shaft receiver 26d of the T-shaped fork connector 26a.

To use the outdoor cooking tool 100, the inner shaft 14b is coupled to the outer shaft 14a, and in embodiments where the shafts 14a 14b are in telescoping relationship, the inner shaft is telescoped out of the outer shaft up to a maximum length of the inner shaft 14b. In embodiments in which the fork 26 is not permanently affixed to the inner shaft 14b, the prongs 26b are coupled to the fork connector 26d, and thus assembled, the fork 26 is coupled to the inner shaft 14b. The bipartite shaft 14 is positioned inside the shaft channel 18d, and held in position by the spring loaded device 18. The stabilizer 20 is positioned on the support 24 such that when the ground end 24a of the support 24 engages the ground surface, an underside of the stabilizer 20 contacts the ground surface. A hotdog or other desired food is pushed onto the prongs 26b of the fork 26 and fork 26 is positioned or repositioned as desired over a heat source, by adjusting the bipartite shaft 14 to a desired position in a vertical arc pivoting about the shaft channel 18d, either upwards away from the heat source, or downwards towards the heat source. The sliding relationship of the shaft 14 to the channel 18d also allows the fork 26 to be slid forward towards the heat source, or backwards, away from the heat source. The fork 26 can also be moved in a horizontal arc about the support 24 by turning the support 24 so as to rotate the support in the ground surface.

To store the outdoor cooking utensil 100, the inner shaft 14b is either removed from or telescoped into the outer shaft 14a, and then then outer shaft 14a is removed from the shaft connector 18, by disengaging or otherwise removing the spring loaded device 18c. The stabilizer 20 and support 24 are removed from the ground surface. The fork 26, in some embodiments, is removed from the fork end 14bb and stored separately, and in other embodiments, the fork prongs 26b are pivoted about the fork connector 26a, resting adjacent the inner shaft 14b.

Numerous other modifications and alternative arrangements may be devised by those skilled in the art without departing from the scope of the present invention. For instance, the inventor notes that the bipartite shaft 14 can also pivot in a horizontal arc about the support 24 by allowing the shaft connector 18 to rotate about the connector end 24b of the support 24. The support 24 itself can also be comprised of telescoping segments, allowing a height of the support 24 to be fully adjustable. The stabilizer 20, while typically removable, may also be permanently affixed to the support 24, and may also be configured in a variety of shapes, such as cross shapes with three or more extending arms, and the disc-shaped shown in the Figures is not meant to limit the stabilizer to disc shapes but rather to suggest one embodiment where the stabilizer body extends outwards from the support. The thickened center design of the stabilizer further maintains the vertical position of the support by increasing the surface area by which the stabilizer engages the support, and thus other shapes that feature a centralized area with a through-bore formed as an elongated channel with outwardly extending members are also suitable embodiments of the stabilizer.

I claim:

1. A cooking utensil, comprising:
a shaft (14) having a fork receiving end (14bb);
a support (24) affixed to the shaft;
a shaft connector (18) coupling the shaft to the support; and
a fork (26) affixed to the fork receiving end (14bb);
wherein the shaft connector (18) is further comprised of a shaft channel (18d) engaging a locking means (18c).

2. The cooking utensil of claim 1, wherein the shaft connector (18) is further comprised of a spring receiving means (18b) adapted to receive a spring loaded device (18c).

3. The spring loaded device (18c) of claim 2, wherein the device is a press fit ball nose spring plunger.

4. The shaft channel (18d) of claim 1, wherein the shaft channel is comprised of a pair of parallel arms in spaced apart relationship having a pair of aligned through bores, and wherein the shaft (14) slideably engages the shaft channel (18d) between the pair of parallel arms and is maintained therein by the spring loaded device (18c).

5. The shaft (14) of claim 1, further comprising an inner shaft (14b) engaging an outer shaft (14a).

6. The shaft (14) of claim 5, wherein the inner shaft (14b) telescopically engages the outer shaft (14a).

7. The fork (26) of claim 1, wherein the fork is comprised of a pair of prongs (26b) arranged as a U-shaped member.

8. The fork (26) of claim 1, further comprising a fork connector (26a) having a pair of prongs (26b) removably coupled to a prong receiver (26c) formed into the fork connector (26a).

9. The fork connector (26a) of claim 8, further comprising a shaft receiver (26d) adapted to engage the fork end (14bb) of the shaft (14).

10. The cooking utensil of claim 1, further comprising a stabilizer (20) having a hole (20a) adapted to receive the support (24), whereby the stabilizer maintains a vertical position of the support when the support is positioned into a ground surface and the stabilizer engages the ground surface.

11. The stabilizer of claim 10, wherein the stabilizer body is further comprised of a centralized thickened portion and a flattened perimeter extending away from the thickened center portion.

12. The stabilizer (20) of claim 11, wherein the stabilizer further comprises a hole (20a) formed as a channel in the center portion of the stabilizer body.

13. The cooking utensil of claim 1, further comprising a handle (22).
